(19) United States
(12) Patent Application Publication
(10) Pub. No.: US 2026/0183704 A1
(43) Pub. Date: Jul. 2, 2026

(54) CARBON DIOXIDE CAPTURING DEVICE AND CARBON DIOXIDE CAPTURING METHOD

(71) Applicants: Samsung Electronics Co., Ltd., Suwon-si (KR); IUCF-HYU (Industry-University Cooperation Foundation Hanyang University), Seoul (KR)

(72) Inventors: Hyoungwoo Choi, Suwon-si (KR); Jin-Kuk Kim, Seoul (KR); Jonggeun Seong, Suwon-si (KR); Jinkyu Kang, Suwon-si (KR); Sungwon Hong, Suwon-si (KR); Se-Jung Kim, Seoul (KR); Yongjae Song, Seoul (KR)

(21) Appl. No.: 19/208,681

(22) Filed: May 15, 2025

(30) Foreign Application Priority Data
Dec. 30, 2024 (KR) 10-2024-0201126

(51) Int. Cl. B01D 53/22; B01D 7/00; B01D 53/26; C01B 32/55

(52) U.S. Cl. CPC B01D 53/229; B01D 7/00; B01D 53/26; C01B 32/55; B01D 2256/22; B01D 2257/102

(57) ABSTRACT

Provided are a carbon dioxide capturing device and method. A gas mixture including carbon dioxide gas is separated into a CO₂-depleted first gas by permeating a nitrogen-selective separation membrane module and CO₂-enriched second gas. The second gas is supplied to a low-temperature sublimator, heat-exchanged with a refrigerant of a refrigerant-based cooling system, and cooled to a second temperature. The carbon dioxide gas included in the second gas is sublimated and separated into solid-phase carbon dioxide and third gas.

### CROSS-REFERENCE TO RELATED APPLICATION

This application claims priority to Korean Patent Application No. 10-2024-0201126, filed on Dec. 30, 2024, in the Korean Intellectual Property Office, and all the benefits accruing therefrom under 35 U.S.C. § 119, the disclosure of which is incorporated by reference herein in its entirety.

### BACKGROUND

### 1. Field

The disclosure relates to a device and method for separating carbon dioxide from a gas mixture and capturing the carbon dioxide.

### 2. Description of the Related Art

In various industrial fields, gas mixtures including carbon dioxide are discharged. Carbon dioxide is a major component of greenhouse gases, and technology of separating and capturing carbon dioxide included in a gas mixture before releasing the gas mixture into the atmosphere is of important interest. Carbon dioxide may be captured in a solid or liquid state. For example, a gas mixture including carbon dioxide may be liquefied by compressing and cooling the gas mixture. The carbon oxide in the solid state may then be separated and captured using low temperature processing. Carbon dioxide in the liquid state may be separated and captured from a concentrated gas mixture using a distillation process after compressing and cooling a gas mixture using a heat exchanger and concentrating the gas mixture at high pressure by using a separation membrane that selectively allows the carbon dioxide to pass therethrough.

### SUMMARY

Provided are a carbon dioxide capturing device and a method of capturing carbon dioxide, e.g., by a method capable of reducing facility scale.

Provided are a carbon dioxide capturing device and method of capturing carbon dioxide capable of reducing energy consumption.

Additional aspects will be set forth in part in the description which follows and, in part, will be apparent from the description, or may be learned by practice of the presented embodiments of the disclosure.

According to an aspect of the disclosure, a carbon dioxide capturing method includes directing a gas mixture including carbon dioxide gas to a separator including a nitrogen-selective separation membrane module, separating the gas mixture into a CO₂-depleted first gas and a CO₂-enriched second gas, directing the CO₂-enriched second gas to a low-temperature sublimator to provided solid-phase carbon dioxide and a third gas, by cooling the CO₂-enriched second gas to a first temperature by heat exchange with a refrigerant of a first refrigerant-based cooling system and isolating the carbon dioxide gas.

As an embodiment, the nitrogen-selective separation membrane module may have a nitrogen permeance of at least 1 gas permission unit (GPU) or more and a nitrogen/carbon dioxide selectivity of at least 2 or more.

As an embodiment, the carbon dioxide capturing method may further include compressing the gas mixture of about 1.2 bars to about 5 bars before providing the gas mixture to the separator.

As an embodiment, the carbon dioxide capturing method may further include removing moisture from the gas mixture, e.g., by passing the gas mixture through a dryer, before providing the gas mixture to the separator.

As an embodiment, the temperature of the gas mixture provided to the separator may be about 10° C. to about 150° C.

As an embodiment, the first temperature may be about −120° C. to about −90° C.

As an embodiment, the carbon dioxide capturing method may further include cooling the CO₂-enriched second gas to a second temperature without a phase change by directing the CO₂-enriched second gas to a heat exchanger before directing the CO₂-enriched second gas to the low-temperature sublimator.

As an embodiment, the second temperature may be about −80° C. to about −50° C.

As an embodiment, the cooling of the CO₂-enriched second gas to the second temperature may include heat-exchanging the second gas with a second refrigerant-based cooling system.

As an embodiment, the cooling of the CO₂-enriched second gas to the second temperature may include recovering cold heat of the third gas by directing the third gas to the heat exchanger and heat-exchanging the third gas with the CO₂-enriched second gas.

As an embodiment, the third gas may be discharged from the heat exchanger as a fourth gas after heat exchange with the second gas, and the cooling of the CO₂-enriched second gas to the second temperature may include decompressing the fourth gas discharged from the heat exchanger through an expander and recovering power.

As an embodiment, the fourth gas may be discharged as a fifth gas after passing through the expander, and the cooling of the second gas to the second temperature may include recovering cold heat of the fifth gas by resupplying the fifth gas to the heat exchanger and heat-exchanging the fifth gas with the CO₂-enriched second gas.

As an embodiment, the fifth gas may be discharged from the heat exchanger as a sixth gas after heat exchange with the CO₂-enriched second gas, and the carbon dioxide capturing method may further include heat-exchanging the sixth gas with a refrigerant in a condenser of the first refrigerant-based cooling system by supplying the sixth gas to the condenser.

As an embodiment, the refrigerant of the first refrigerant-based cooling system may include a mixed refrigerant including methane, ethane, ethylene, propane, and butane.

As an embodiment, the mixed refrigerant may include about 10 mol % to about 40 mol % of methane, about 10 mole percent (mol %) to about 30 mol % of ethane, about 10 mol % to about 40 mol % of ethylene, about 10 mol % to about 15 mol % of propane, and about 10 mol % to about 40 mol % of butane.

According to another aspect of an embodiment, a carbon dioxide capturing device includes a compressor configured to compress a gas mixture including carbon dioxide to about 1.2 bars to about 5 bars, a separator including a nitrogen-selective separation membrane module to separate the gas mixture into a CO₂-depleted first gas and CO₂-enriched second gas, where the CO₂-depleted first gas permeates the nitrogen-selective separation membrane module, a first refrigerant-based cooling system, and a low-temperature sublimator configured to separate the CO₂-enriched second gas into solid-phase carbon dioxide and a third gas by cooling the CO₂-enriched second gas to about 120° C. to about −90° C. through heat exchange with a refrigerant of the first refrigerant-based cooling system and isolating the carbon dioxide gas, e.g., by sublimation.

As an embodiment, the nitrogen-selective separation membrane module may have a nitrogen permeance of at least 1 GPU or more and a nitrogen/carbon dioxide selectivity of at least 2 or more.

As an embodiment, the carbon dioxide capturing device may further include a heat exchanger configured to cool the CO₂-enriched second gas to about −80° C. to about-50° C. without a phase change by heat-exchanging the CO₂-enriched second gas with the third gas before providing the CO₂-enriched second gas to the low-temperature sublimator.

As an embodiment, the third gas may be discharged from the heat exchanger as fourth gas after heat exchange with the second gas, the carbon dioxide capturing device may further include an expander configured to expand the fourth gas to an atmospheric pressure and discharge the fourth gas as fifth gas, and the fifth gas may be resupplied to the heat exchanger and heat-exchanged with the CO₂-enriched second gas.

As an embodiment, the fifth gas may be discharged from the heat exchanger as sixth gas after heat exchange with the CO₂-enriched second gas, and the sixth gas may be supplied to a condenser of the first refrigerant-based cooling system and heat-exchanged with the refrigerant in the condenser.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic block diagram of a carbon dioxide capturing device according to an embodiment;

FIG. 2 is a schematic block diagram of a refrigerant-based cooling system according to an embodiment;

FIG. 3 is a phase equilibrium diagram showing pressure (atmosphere, atm) versus temperature (Celsius,° C.) of carbon dioxide;

FIG. 4 is a schematic block diagram of a carbon dioxide capturing device according to an embodiment;

FIG. 5 is a schematic block diagram of a carbon dioxide capturing device according to an embodiment;

FIG. 6 is a schematic block diagram of a carbon dioxide capturing device according to an embodiment; and

FIG. 7 is a schematic block diagram of a carbon dioxide capturing device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a carbon dioxide capturing device and method will be described in detail with reference to the accompanying drawings. In the drawings, like reference numerals in the drawings denote like elements, and sizes of components in the drawings may be exaggerated for clarity and convenience of explanation. While such terms as “first,” “second,” etc., may be used to describe various components, such components must not be limited to the above terms. The above terms are used only to distinguish one component from another

An expression used in the singular encompasses the expression of the plural, unless it has a clearly different meaning in the context. When a portion “includes” a component, another component may be further included, rather than excluding the existence of the other component, unless otherwise described. Sizes or thicknesses of components in the drawings may be arbitrarily exaggerated for convenience of explanation. In addition, when a certain material layer is described as being arranged on a substrate or another layer, the material layer may be in contact with the other layer, or there may be a third layer between the material layer and the other layer. In the following embodiment, materials constituting each layer are provided merely as an example, and other materials may also be used.

Moreover, the terms “part,” “module,” etc. refer to a unit processing at least one function or operation, and may be implemented by a hardware, a software, or a combination thereof.

The particular implementations shown and described herein are illustrative examples of embodiments and are not intended to otherwise limit the scope of embodiments in any way. For the sake of brevity, conventional electronics, control systems, software development and other functional aspects of the systems may not be described in detail. In addition, the connecting lines, or connectors shown in the various figures presented are intended to represent functional relationships and/or physical or logical couplings between the various elements. It should be noted that many alternative or additional functional relationships, physical connections or logical connections may be present in a practical device.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

“At least one” is not to be construed as limiting “a” or “an.” “Or” means “and/or.” As used herein, the term “and/or” includes any and all combinations of one or more of the associated listed items.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Operations of all methods described herein may be performed in any suitable order unless otherwise indicated herein or otherwise clearly contradicted by context. In addition, the use of any and all exemplary languages (e.g., “such as”) provided herein, are intended merely to better illuminate the technical ideas and does not pose a limitation on the scope of rights unless otherwise claimed.

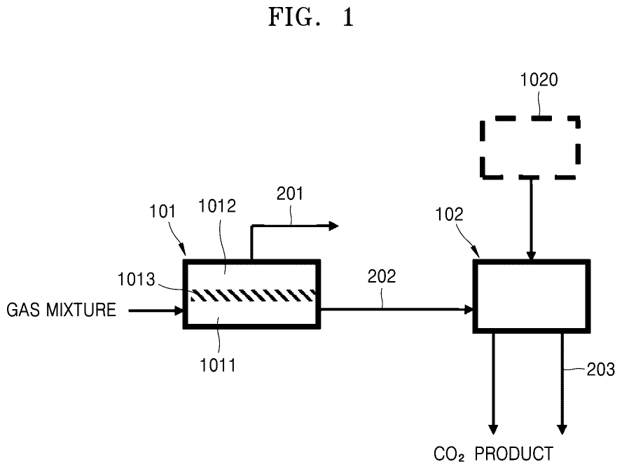

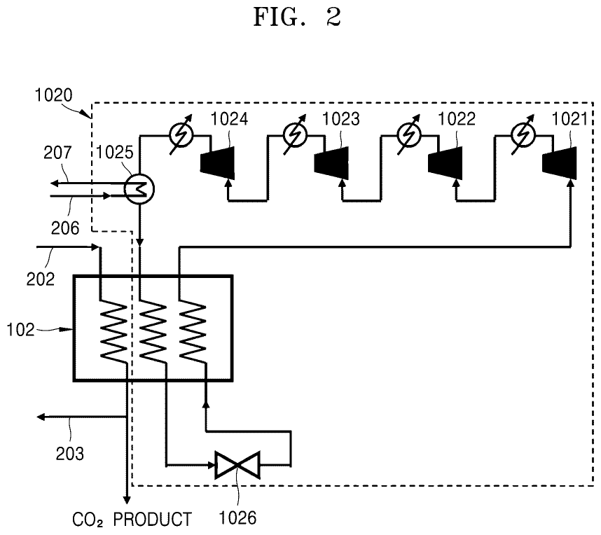

FIG. 1 is a schematic block diagram of a carbon dioxide capturing device according to an embodiment. FIG. 2 is a schematic block diagram of a refrigerant-based cooling system 1020 according to an embodiment. Referring to FIGS. 1 and 2, the carbon dioxide capturing device according to an embodiment may include a separator 101 and a low-temperature sublimator 102. The separator 101 uses a nitrogen-selective separation membrane module 1013 to separate a gas mixture including carbon dioxide gas into CO₂-depleted first gas 201 by passing through the nitrogen-selective separation membrane module 1013 and CO₂-enriched second gas 202. The low-temperature sublimator 102 separates the second gas 202 into solid-phase carbon dioxide and a third gas 203, by cooling the second gas 202 to a first temperature. A carbon dioxide gas product is then isolated by sublimation of the solid-phase carbon dioxide or the solid-phase carbon dioxide is recovered.

The gas mixture may include at least 1 mol % or more of carbon dioxide gas, for example, about 5 mol % e to about 40 mol %. The gas mixture may further include nitrogen, oxygen, moisture, and a trace amount of another gas component. The temperature of the gas mixture may be about 10° C. to about 150° C. For example, the temperature of the gas mixture may be about 20° C. to about 90° C. The pressure of the gas mixture may be, for example, about 1.01 bars to about 1.5 bars.

The carbon dioxide capturing device according to an embodiment includes a separator 101 to concentrate the carbon dioxide gas in the gas mixture by using a nitrogen-selective separation membrane module 1013. The nitrogen-selective separation membrane module 1013 has a high selectivity for nitrogen over that of carbon dioxide. For example, the nitrogen/carbon dioxide selectivity of the nitrogen-selective separation membrane module 1013 may be 2 or more. The nitrogen permeance of the nitrogen-selective separation membrane module 1013 may be 1 gas permission unit (GPU) or more. The GPU refer to a volume flow rate per unit area and unit pressure, and

$$1 G P U = 1 \times 1 {0}^{6} \frac{{cm}^{3} ( S T P )}{{cm}^{2} \cdot cmHg \cdot sec} .$$

For example, a cellulose acetate separation membrane (CA/Si-CL) including p-tert-butylcalix[4] arene-immobilized silica (CL-Si) may have a nitrogen permeance of about 1,949 and a nitrogen/carbon dioxide selectivity of about 23.5 and be employed in the nitrogen-selective separation membrane module 1013. The nitrogen-selective separation membrane module 1013 is not limited thereto. For example, a polyethyleneimine separation membrane including a porous MCM-48 material may have a nitrogen permeance of about 27 GPU and a nitrogen/carbon dioxide selectivity of about 3 and be employed in the nitrogen-selective separation membrane module 1013. As another example, a Poly (ethylenimine) (PEI)-based separation membrane such as a PEI-based separation membrane including MCM-48 and a PEI-based separation membrane including Aziridine-Functionalized Mesoporous Silica, a poly (triazine imide) (PTI)-based separation membrane, a polyurea-based separation membrane, etc. may be employed in the nitrogen-selective separation membrane module 1013.

As an embodiment, the separator 101 may include a first chamber 1011 and a second chamber 1012. The nitrogen-selective separation membrane module 1013 is disposed between the first chamber 1011 and the second chamber 1012. One separation membrane module 1013 is shown in the present embodiment, but is not limited thereto. For example, the separator 101 may have a multi-stage structure in which two or more separation membrane modules are sequentially arranged. The separation method of the nitrogen-selective separation membrane module 1013 is not particularly limited. For example, the separation method may be diverse, such as a counter-current method, a co-current method, a cross-flow method, a sweep flow method, etc.

The gas mixture is introduced into the first chamber 1011. The nitrogen gas included in the gas mixture passes through the nitrogen-selective separation membrane module 1013 and moves to the second chamber 1012 to be discharged from the separator 101 as depleted first gas 201. The concentration carbon dioxide in the first chamber 1011 increases relative to the gas mixture. The concentrated carbon dioxide gas is discharged from the first chamber 1011. Accordingly, the gas mixture may be separated into a nitrogen-enriched gas, i.e., the CO₂-depleted first gas 201, by permeating the nitrogen-selective separation membrane module 1013 and the CO₂-enriched second gas 202 by not permeating the nitrogen-selective separation membrane module 1013.

In general, in a gas mixture, e.g., a combustion gas, a composition ratio of nitrogen is greater than that of carbon dioxide. For example, the composition ratio of nitrogen in the gas mixture may be about 80%, while the composition ratio of carbon dioxide may be about 16%. Accordingly, if one was to use a carbon dioxide-selective separation membrane module about 90% or more of carbon dioxide in the gas mixture would need to permeate through the carbon dioxide-selective separation membrane module, and therefore, a membrane area of very large size would be required. In contrast, in accordance to an embodiment, if the nitrogen gas permeates through a nitrogen-selective separation membrane module 1013, because the composition ratio of nitrogen in the gas mixture is four times or more than that of carbon dioxide, a larger flow rate of nitrogen may be permeated with a significantly smaller membrane area. However, as the membrane area of the nitrogen-selective separation membrane module 1013 increases one can expect the permeation amount of nitrogen to increase, however, the inventors also realized that the permeation amount of carbon dioxide through the membrane also increases with larger membrane area, and thus, reduce a carbon dioxide recovery rate or separation efficiency. In consideration of this balance if membrane size, the membrane area of the nitrogen-selective separation membrane module 1013 may be appropriately selected to reduce cold heat required in a low-temperature sublimation process to be described below and simultaneously achieve a target carbon dioxide recovery rate. For example, the membrane area when using a nitrogen-selective separation membrane module 1013 may be about 1/12 (one-twelfth) the size compared to the membrane area when using a carbon dioxide-selective separation membrane module.

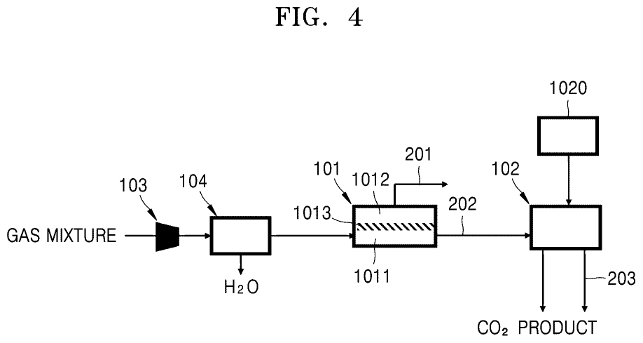

The pressure of the gas mixture provided to the separator 101 may be about 1.2 bars to about 5.0 bars. When necessary, a compressor (103 of FIG. 4) compressing the gas mixture to about 1.2 bars to about 5.0 bars may be provided in the previous step of the separator 101. Because the second gas 202 is gas that does not pass through the nitrogen-selective separation membrane module 1013, there is little pressure drop of the second gas 202 in a process of concentrating the carbon dioxide gas. Therefore, a compression process and a compressor for increasing the pressure of the second gas 202 are not required in the process after the separator 101, the structure of the carbon dioxide capturing device may be simplified, and the cost of the device and energy cost may be reduced.

The pressure of the gas mixture provided to the separator 101 is a driving pressure for permeating nitrogen through the nitrogen-selective separation membrane module 1013 in the separator 101, and the higher the driving pressure, the greater the nitrogen permission rate. However, as described below, the carbon dioxide capturing device of the present embodiment separates carbon dioxide in a solid state through a sublimation process from the second gas 202 in which carbon dioxide is concentrated, and the amount of energy (power) required for the sublimation process is affected by the driving pressure.

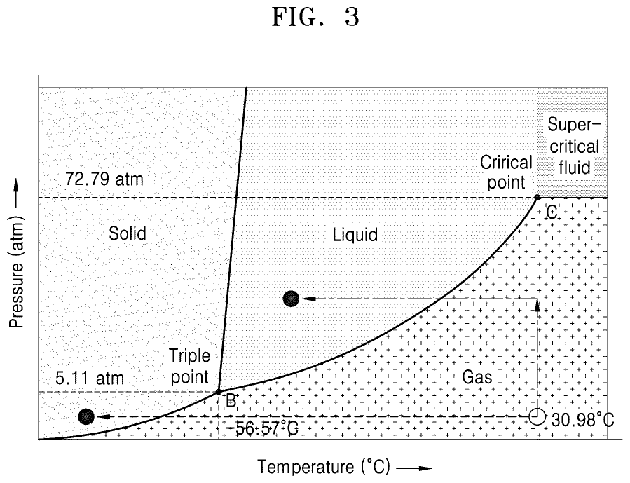

FIG. 3 is a phase equilibrium diagram of carbon dioxide. Referring to FIG. 3, the lower the pressure of carbon dioxide gas, more energy is required for cooling. For example, when the pressure of carbon dioxide gas is at or below atmospheric pressure, a lot of cold heat is required to sublimate the carbon dioxide gas, and the amount of cold heat increases steeply as the pressure decreases. As the pressure increases, even the amount of cold heat required for sublimation does not change significantly, but the temperature at which sublimation occurs rises, and as a result, the amount of energy (power) required to cool the gas to the temperature at which sublimation occurs decreases. In other words, the phase change energy required for sublimation itself does not change significantly with pressure, but due to the operation characteristics of a cooling cycle, the higher the target temperature, the less power is required for the operation of the cooling cycle.

In view of this, the pressure of the gas mixture provided to the separator 101 may be at least atmospheric pressure or higher, for example, 1.2 bars or more. As the pressure increases, the amount of cold heat required for sublimation decreases. The sublimation process is a process of directly changing a phase from a gaseous state to a solid state without undergoing a liquid state in a static pressure state as shown by a dashed line ‘in FIG. 3. When carbon dioxide is cooled at a pressure of about 5.11 atm, that is, 5.18 bars or more, the phase is changed from a gaseous state to a solid state through a liquid state. In other words, when the pressure is higher than the pressure of a triple point of carbon dioxide, unwanted liquefaction is involved in a cooling process. In view of this, the pressure of the gas mixture provided to the separator 101 may be less than or equal to the pressure of the triple point of carbon dioxide, for example, 5.0 bars or less. As described above, because the pressure of the gas mixture in the separator 101 is almost maintained, the pressure of the second gas 202 from the separator 101 is about 1.2 bars to about 5.0 bars. Therefore, the second gas 202 may be provided to the low-temperature sublimator 102 without an additional compression process.

The second gas 202 discharged from separator 101 is provided to the low-temperature sublimator 102. The low-temperature sublimator 102 cools the second gas 202 to a first temperature through heat exchange with a refrigerant of the refrigerant-based cooling system (first refrigerant-based cooling system) 1020. The first temperature may be selected so that sublimation occurs by cooling in consideration of the pressure of the second gas 202. For example, the first temperature may be about −120° C. to about −90° C.

The refrigerant-based cooling system 1020 according to an embodiment is shown in FIG. 2. Referring to FIG. 2, the refrigerant-based cooling system 1020 may include compressors 1021, 1022, 1023, and 1024, a condenser 1025, and a low-temperature sublimator 102 as a heat exchanger. The refrigerant-based cooling system 1020 may further include an expander 1026 expanding the refrigerant discharged from the low-temperature sublimator 102. The expander 1026 may include, for example, an expansion valve. The refrigerant that has passed through the expander 1026 may be provided to the compressor 1021 after passing through the low-temperature sublimator 102 again and exchanging heat with the second gas 202.

The refrigerant used in the refrigerant-based cooling system 1020 may include one or more hydrocarbons for cryogenic cooling. The refrigerant may be a single refrigerant or a mixed refrigerant. For example, the single refrigerant may be propane. For example, the mixed refrigerant may be a mixture including methane, ethane, ethylene, propane, and butane. For example, the mixed refrigerant may include about 10 mol % to about 40 mol % of methane, about 10 mol % to about 30 mol % of ethane, about 10 mol % to about 40 mol % of ethylene, about 10 mol % to about 15 mol % of propane, and about 10 mol % to about 40 mol % of butane.

The compressors 1021, 1022, 1023, and 1024 compress the refrigerant discharged from the low-temperature sublimator 102. The refrigerant that has passed through the low-temperature sublimator 102 may be compressed to about 15 bars to about 30 bars by the compressors 1021, 1022, 1023, and 1024. In the present embodiment, a multi-stage compression structure including the four compressors 1021, 1022, 1023, and 1024 is employed, but is not limited thereto. The number of compressors may be one, two, three, five, or more. The compressors 1021, 1022, 1023, and 1024 may all have the same compression ratio, and at least one thereof may have a different compression ratio from those of the others. The compression ratio of each of the compressors 1021, 1022, 1023, and 1024 may be about 1.1 to about 2. The number of compressors may be appropriately determined in consideration of a compression ratio and an operation efficiency of each compressor. The refrigerant may be cooled to, for example, room temperature in an outlet of each of the compressors 1021, 1022, 1023, and 1024.

The condenser 1025 condenses a high-pressure refrigerant gas into a high-pressure liquid refrigerant. Heat generated during a condensation process is discharged through heat exchange with the outside. The condensed refrigerant is provided to the low-temperature sublimator 102 and exchanges heat with the second gas 202 (primary heat exchange) to cool the second gas 202 to the first temperature. The carbon dioxide gas included in the second gas 202 is sublimated so that the second gas 202 is separated into solid-phase carbon dioxide and the remaining third gas 203. The solid-phase carbon dioxide is recovered. The concentration of carbon dioxide of a flow including the solid-phase carbon dioxide may be 99.9% or more. The concentration of carbon dioxide of the third gas 203 may be about 5% or less.

The gas-liquid mixed refrigerant discharged from the low-temperature sublimator 102 may be provided to the compressors 1021, 1022, 1023, and 1024 to repeat the above-described cooling cycle. As shown in FIG. 2, the gas-liquid mixed refrigerant discharged from the low-temperature sublimator 102 is decompressed and adiabatically cooled while passing through the expander 1026. In the expander 1026, the refrigerant is decompressed until reaching a temperature capable of providing a cooling effect required in the low-temperature sublimator 102. For example, the temperature and pressure of the refrigerant that has passed through the expander 1026 may be about −125° C. to about-75° C. and about 3 bars to about 10 bars, respectively. The gas-liquid mixed refrigerant that has been decompressed and cooled through the expander 1026 is again provided to the low-temperature sublimator 102 and exchanges heat with the second gas 202 (secondary heat exchange) to cool the second gas 202. Accordingly, the efficiency of the refrigerant-based cooling system 1020 may be improved. After the secondary heat exchange, the gas-liquid mixed refrigerant discharged from the low-temperature sublimator 102 is provided to the compressors 1021, 1022, 1023, and 1024 to repeat the above-described cooling cycle.

In industry fields such as cement, steel, power generation, biogas, shipbuilding, petrochemicals, and semiconductors, gas mixtures including carbon dioxide are discharged, and measures to capture carbon dioxide from the gas mixtures have been proposed. In the measure to separate carbon dioxide into a solid state by low temperature processing, the process is complicated and requires distillation facilities, which requires large scales of the facilities and high energy consumption. Capture of carbon dioxide in low temperature processing is mainly based on amine-based absorbers, which causes problems such as deterioration of amine-based absorbers and generation of by-products. The measure to using a carbon dioxide selective separation membrane has no by-products and relatively small facility scales, but has a relatively low purity of carbon dioxide. To obtain high purity carbon dioxide, distillation facilities are required after a separation membrane process. In addition, because carbon dioxide is separated into liquid-phase carbon dioxide, compression (e.g., about 50 bar) and cooling of the gas mixture in which carbon dioxide is concentrated are required as indicated by a dashed line in FIG. 3, which requires high energy consumption.

The carbon dioxide capturing device according to the disclosure includes a nitrogen-selective separation membrane module 1013 to separate nitrogen from the gas mixture and obtain a second gas 202 in which carbon dioxide is concentrated from the gas mixture. As described above, the nitrogen-selective separation membrane module 1013 may concentrate carbon dioxide to a desired level even with a small separation membrane area. Therefore, the small and compact separator 101 may be achieved. Because there is little pressure drop of the gas mixture in the process of concentrating carbon dioxide in the separator 101, the pressure of the second gas 202 in which carbon dioxide is concentrated is similar to the pressure of the gas mixture provided to the separator 101. There is little need to compress the second gas 202 before providing the second gas 202 to a low-temperature sublimation process, which is a post-process. Therefore, the compression process may be omitted between the separation (concentration) process and the sublimation process, and thus facility costs and operating energy costs may be reduced.

The carbon dioxide capturing device according to an embodiment provides for the forming of solid-phase carbon dioxide from the carbon dioxide gas included in the second gas 202 by using the low-temperature sublimator 102. The carbon dioxide capturing device that captures solid-phase carbon dioxide by the low-temperature sublimation process is much smaller of facility scale compared to a liquid carbon dioxide capturing device that requires a high-pressure process or a solid-state carbon dioxide capturing device using distillation facilities. Therefore, a compact carbon dioxide capturing device capable of capturing solid-phase carbon dioxide may be implemented. In addition, because there is no distillation facility, the carbon dioxide capturing device may be applied to carbon dioxide discharge facilities adjacent to residential areas.

FIG. 4 is a schematic block diagram of a carbon dioxide capturing device according to an embodiment. The carbon dioxide capturing device of the present embodiment is different from the carbon dioxide capturing device shown in FIG. 1 in that the carbon dioxide capturing device further includes a compressor 103 and a dryer 104. Hereinafter, differences will be mainly described, components performing the same function will be indicated by the same reference numerals, and redundant descriptions thereof will be omitted.

Referring to FIG. 4, the carbon dioxide capturing device according to an embodiment may further include the compressor 103 that compresses a gas mixture before being provided to the separator 101. The compressor 103 may compress a gas mixture of, for example, about 1.01 bars to about 1.5 bars to, for example, about 1.2 bars to about 5.0 bars. Accordingly, an appropriate driving pressure for permeating nitrogen through the nitrogen-selective separation membrane module 1013 in the separator 101 may be provided.

The carbon dioxide capturing device according to an embodiment may further include the dryer 104 removing moisture included in the compressed gas mixture. The dryer 104 may be disposed between the compressor 103 and the separator 101. After passing through the dryer 104, moisture content in the gas mixture may be about 50 parts per million by volume (ppmv) or less.

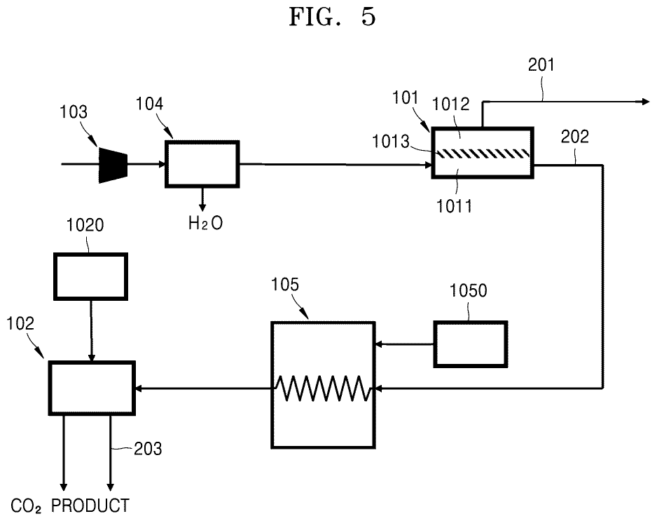

FIG. 5 is a schematic block diagram of a carbon dioxide capturing device according to an embodiment. The carbon dioxide capturing device of the present embodiment is different from the carbon dioxide capturing device shown in FIG. 4 in that the carbon dioxide capturing device further includes a heat exchanger 105. Hereinafter, differences will be mainly described, components performing the same function will be indicated by the same reference numerals, and redundant descriptions thereof are omitted.

Referring to FIG. 5, the carbon dioxide capturing device according to an embodiment may further include a heat exchanger 105 cooling the second gas 202 discharged from the separator 101 to a second temperature without a phase change. The second temperature is a temperature that does not cause a phase change of carbon dioxide gas and may be higher than a first temperature. For example, the second temperature may be about −80° C. to about −50° C. As an embodiment, the heat exchanger 105 may cool the second gas 202 to the second temperature through heat exchange with a refrigerant of a refrigerant-based cooling system (second refrigerant-based cooling system). With respect to the refrigerant-based cooling system 1050, the description of the refrigerant-based cooling system 1020 described above may be applied. However, the number of compression stages, the type of refrigerant, and the operating temperature of the refrigerant-based cooling system 1050 may be different from those of the refrigerant-based cooling system 1020. Although not shown in the drawing, the refrigerant-based cooling system 1050 is omitted, and a refrigerant of the refrigerant-based cooling system 1020 may be partially provided to the heat exchanger 105 and exchange heat with the second gas 202 to cool the second gas 202 to the second temperature.

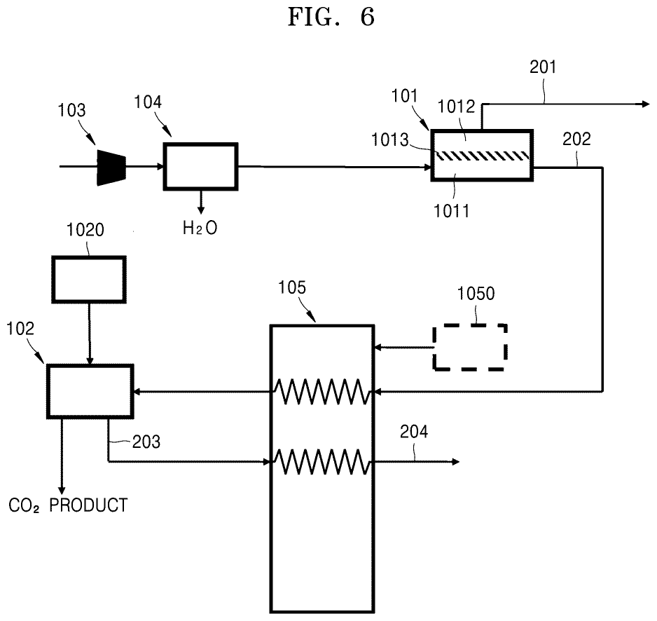

FIG. 6 is a schematic block diagram of a carbon dioxide capturing device according to an embodiment. The carbon dioxide capturing device of the present embodiment is different from the carbon dioxide capturing device shown in FIG. 5 in that the carbon dioxide capturing device has a structure capable of recovering cold heat from the third gas 203. Hereinafter, differences will be mainly described, components performing the same function will be indicated by the same reference numerals, and redundant descriptions thereof will be omitted.

Referring to FIG. 6, the third gas 203 discharged from the low-temperature sublimator 102 is a gas of relatively low temperature and high pressure. For example, the temperature of the third gas 203 may be about −120° C. to about −70° C., and the pressure may be about 1.2 bars to about 5.0 bars. As measure to recover the cold heat of the third gas 203, the third gas 203 may be provided to the heat exchanger 105. In the heat exchanger 105, the third gas 203 may exchange heat with the second gas 202 (primary heat exchange) so that the second gas 202 may be cooled to a second temperature without a phase change. The heat exchanger 105 may be in the shape of a cold box as a whole. The third gas 203 is discharged from the heat exchanger 105 as fourth gas 204 of which the temperature has risen after heat exchange with the second gas 202.

Accordingly, the cold heat of the third gas 203 is provided to the second gas 202, and thus the load of the refrigerant-based cooling system 1050 may be reduced. When the second gas 202 may be cooled to the second temperature by the cold heat of the third gas 203, the refrigerant-based cooling system 1050 may be omitted, and thus the facility scale of the carbon dioxide capturing device may be reduced. The second gas 202 is cooled to the second temperature and then provided to the low-temperature sublimator 102, and thus the operating load of the refrigerant-based cooling system 1020 may be reduced. Furthermore, carbon dioxide is sublimated by cooling in two stages, and thus energy may be saved through optimization of operation of the refrigerant-based cooling system 1020.

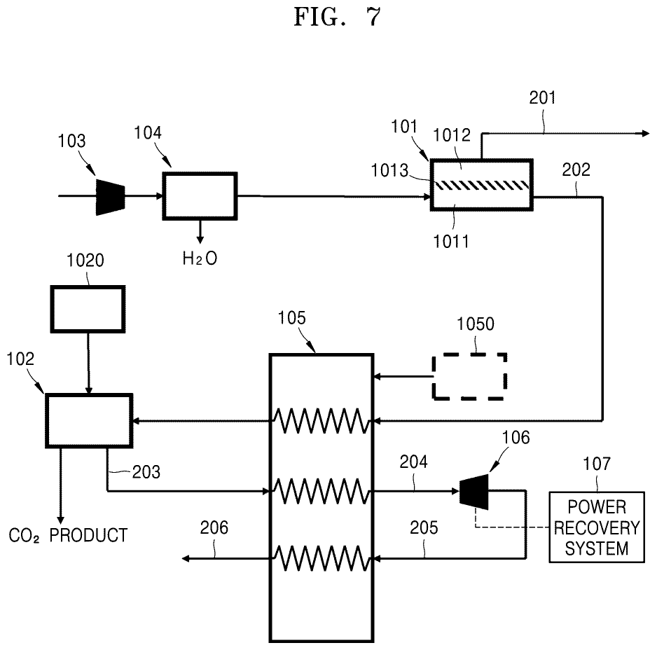

FIG. 7 is a schematic block diagram of a carbon dioxide capturing device according to an embodiment. The carbon dioxide capturing device of the present embodiment is different from the carbon dioxide capturing device shown in FIG. 6 in that the carbon dioxide capturing device has a structure capable of recovering energy of the fourth gas 204 as cold heat and electricity. Hereinafter, differences will be mainly described, components performing the same function will be indicated by the same reference numerals, and redundant descriptions thereof will be omitted.

Referring to FIG. 7, the pressure of the fourth gas 204 discharged from the heat exchanger 105 after heat exchange between the second gas 202 and the third gas 203 is almost maintained at, for example, about 1.2 bars to about 5.0 bars. The carbon dioxide capturing device of the embodiment may further include an expander 106. For example, the expander 106 may decompress the fourth gas 204 to atmospheric pressure. The fourth gas 204 passes through the expander 106 and is discharged as fifth gas 205 having the atmospheric pressure and a temperature of about −120° C. to about −70° C. The fifth gas 205 is provided to the heat exchanger 105. In the heat exchanger 105, the fifth gas 205 may exchange heat with the second gas 202 (secondary heat exchange) so that the second gas 202 may be cooled. The heat exchanger 105 may be in the shape of a cold box as a whole. The expander 106 may be a turbine-based expander. A power recovery system 107 is connected to the turbine-based expander 106 to recover power in a process of decompressing the fourth gas 204. Although not shown in the drawings, the power recovery system 107 includes a generator connected to the turbine-based expander 106. The high-pressure fourth gas 204 decreases its pressure and temperature while passing through the turbine-based expander 106, and produces axial energy of a turbine during this process. A generator is driven by the axial energy of the turbine, and mechanical axial energy is converted into electrical energy.

Accordingly, cold heat of the third gas 203 may be provided to the second gas 202 in two stages, and thus the load of the refrigerant-based cooling system 1050 may be reduced. When the second gas 202 is cooled to a second temperature by recovering the cold heat of the third gas 203 in two stages, the refrigerant-based cooling system 1050 may be omitted, and thus the facility scale of the carbon dioxide capturing device may be reduced. The second gas 202 is cooled to the second temperature and then provided to the low-temperature sublimator 102, and thus the operating load of the refrigerant-based cooling system 1020 may be reduced, thereby saving energy. In addition, electrical energy may be recovered from the fourth gas 204 during a depressurization process in the expander 106, and thus energy may be further saved. After the secondary heat exchange, the fifth gas 205 is discharged from the heat exchanger 105 as the sixth gas 206 of which the temperature has risen.

The temperature of the sixth gas 206 is, for example, about −40° C. to about −10° C., and has considerable cold heat. As shown in FIG. 2, the sixth gas 206 may be provided to the condenser 1025 of the refrigerant-based cooling system 1020. The sixth gas 206 may be discharged as seventh gas 207 by providing cold heat to the condenser 1025 and then cooling the refrigerant passing through the condenser 1025. The temperature of the seventh gas 207 may be, for example, room temperature. Accordingly, most of the cold heat of the third gas 203 may be recovered, and thus the energy efficiency of the carbon dioxide capturing device may be improved.

Hereinafter, embodiments of a carbon dioxide capturing method will be described with reference to FIGS. 1 to 7. According to an embodiment, the carbon dioxide capturing method may include providing a gas mixture including carbon dioxide gas to the separator 101 including the nitrogen-selective separation membrane module 1013, separating the gas mixture into the CO₂-depleted first gas 201 by permeating the nitrogen-selective separation membrane module 1013 and the CO₂-enriched second gas 202, and separating, by the low-temperature sublimator 102, the second gas 202 into solid-phase carbon dioxide and the third gas 203, by cooling the second gas 202 to a first temperature by heat exchange with a refrigerant of the refrigerant-based cooling system 1020 and sublimating carbon dioxide gas included in the second gas 202.

The gas mixture may be discharged from various sources. For example, the gas mixture may be discharged from industry fields such as cement, steel, power generation, biogas, shipbuilding, petrochemicals, and semiconductors. The gas mixture may include at least 1 mol % or more of carbon dioxide gas, for example, about 3 mol % to about 40 mol %. Besides, the gas mixture may further include nitrogen, oxygen, moisture, and a trace amount of another gas component. The temperature of the gas mixture may be about 10° C. to about 150° C. For example, the temperature of the gas mixture may be about 20° C. to about 90° C. The pressure of the gas mixture may be, for example, about 1.01 bars to about 1.5 bars.

As shown in FIG. 4, the gas mixture may be compressed by the compressor 103 to provide a driving pressure to the nitrogen-selective separation membrane module 1013 before being provided to the separator 101. To this end, the carbon dioxide capturing method according to an embodiment may further include compressing the gas mixture to about 1.2 bars to about 5 bars before providing the gas mixture to the separator 101. The operating conditions of the compressor 103 according to an embodiment are shown in Table 1 below.

TABLE 1

| | | |
|---|---|---|
| Compressor 101 | Unit | Condition |

| | | | |
|---|---|---|---|
| Pressure | Inlet | bar(a) | 1.01 |
| | Outlet | | 2.85 |
| Temperature | inlet | ° C. | 57 |
| | Outlet | | 30 |

| | | |
|---|---|---|
| Electric energy usage | MW | 79 |

Referring to Table 1, a gas mixture of 1.01 bars and 57° C. may be provided to the compressor 103. The gas mixture may be compressed to, for example, about 2.85 bars by the compressor 103. The temperature of the gas mixture that has passed through the compressor 103 may be, for example, about 30° C. When necessary, the gas mixture that has passed through the compressor 103 may be cooled to a temperature suitable for a subsequent separation process.

When the gas mixture includes moisture, as shown in FIG. 4, moisture may be removed from the gas mixture by using the dryer 104 before being provided to the separator 101. To this end, the carbon dioxide capturing method according to an embodiment may further include removing moisture from the gas mixture by passing the gas mixture through a dryer 104 before providing the gas mixture to the separator 101. For example, a drying operation may be performed after a compression operation. Moisture content in the gas mixture after passing through the dryer 104 may be 50 ppmv or less. Table 2 below shows an example of material compositions and states of the gas mixture in the inlet and outlet of the compressor 103, and an outlet of the dryer 104. In Table 2 below, it is assumed that moisture has been entirely removed through a drying process.

TABLE 2

| | | Inlet of | Outlet of | Outlet of |
|---|---|---|---|---|
| | | Compressor 103 | Compressor 103 | Dryer 104 |
| Temperature (° C.) | | 57 | 30 | 30 |
| Pressure (bar) | | 1.01 | 2.85 | 2.85 |
| Flow rate (kmol/h) | | 73481 | 65411 | 62334 |
| Composition | CO₂ | 0.135 | 0.152 | 0.159 |
| | N₂ | 0.681 | 0.765 | 0.803 |
| | O₂ | 0.032 | 0.036 | 0.038 |
| | H₂O | 0.152 | 0.047 | 0.000 |

After compression and drying processes, the gas mixture is provided to the separator 101. For example, the nitrogen permeance of the nitrogen-selective separation membrane module 1013 is 1,949, and the nitrogen/carbon dioxide selectivity is 23.5. The membrane area of the nitrogen-selective separation membrane module 1013 is, for example, 93,728 m², and a cross-flow method is used as a separation method.

The gas mixture that has passed through the dryer 104 is provided to the first chamber 1011 of the separator 101. Nitrogen in the gas mixture permeates the nitrogen-selective separation membrane module 1013 and moves to the second chamber 1012. The residual gas that has not permeated the nitrogen-selective separation membrane module 1013 remains in the first chamber 1011. As the nitrogen gas escapes from the gas mixture, the concentration of carbon dioxide in the gas mixture remaining in the first chamber 1011 increases, and thus carbon dioxide gas may concentrate. Accordingly, the gas mixture may be separated into the nitrogen-enriched first gas 201, i.e., the CO₂-depleted first gas 201, by permeating the nitrogen-selective separation membrane module 1013 and the CO₂-enriched second gas 202 by not permeating the nitrogen-selective separation membrane module 1013. Table 3 shows an example of a material composition and state of each of the gas mixture in the inlet of the separator 101, the first gas 201, and the second gas 202.

TABLE 3

| | | Inlet of | First | Second |
|---|---|---|---|---|
| Flow | | Separator 101 | gas 201 | gas 202 |
| Temperature (° C.) | | 30 | 30 | 30 |
| Pressure (bar) | | 2.85 | 1.01 | 2.85 |
| Flow rate (kmol/h) | | 62334 | 24553 | 37781 |
| Composition | CO₂ | 0.159 | 0.020 | 0.250 |
| | N₂ | 0.803 | 0.980 | 0.687 |
| | O₂ | 0.038 | 0.000 | 0.063 |
| | H₂O | 0.000 | 0.000 | 0.000 |

Referring to Table 3, a composition ratio of carbon dioxide in the gas mixture introduced into the separator 101 is about 0.159, and a composition ratio of carbon dioxide concentrated by the separator 101 in the second gas 202 is about 0.250. Because a pressure drop occurs while nitrogen in the gas mixture passes through the nitrogen-selective separation membrane module 1013, the pressure of the first gas 201 may be, for example, 1.01 bars. The first gas 201 may be discharged to the outside through a flue duct. Because the second gas 202 does not permeate the nitrogen-selective separation membrane module 1013, the pressure of the second gas 202 may be maintained at, for example, 2.85 bars.

Although not shown in the drawings, part of the first gas 201 may be provided to the separator 101, for example, the first chamber 1011, as sweep gas. According to this, because the concentration of nitrogen inside the first chamber 1011 increases, a difference in nitrogen partial pressures between the first chamber 1011 and the second chamber 1012 increases so that nitrogen may rapidly pass through the nitrogen-selective separation membrane module 1013. Therefore, the separation efficiency of the nitrogen-selective separation membrane module 1013 may be improved, thereby reducing the separation membrane area required to concentrate carbon dioxide to a desired concentration.

The second gas 202 may be provided to the low-temperature sublimator 102. In the low-temperature sublimator 102, the second gas 202 is cooled to a first temperature by heat exchange with a refrigerant of the refrigerant-based cooling system 1020. The first temperature is a temperature at which the carbon dioxide gas included in the second gas 202 is sublimated. For example, the first temperature may be about −120° C. to about −90° C.

The refrigerant may include one or more hydrocarbons for cryogenic cooling. The refrigerant may be a single refrigerant or a mixed refrigerant. In the present embodiment, the mixed refrigerant including methane, ethane, ethylene, propane, and butane is used as the refrigerant. Table 4 shows an example of a composition and flow rate of the mixed refrigerant.

TABLE 4
Refrigerant Conditions

| Flow rate (kmol/h) | | | 82200 |
|---|---|---|---|
| | Composition | Methane | 0.314 |
| | | Ethane | 0.083 |
| | | Ethylene | 0.297 |
| | | Propane | 0.075 |
| | | n-Buthane | 0.231 |

For example, a four-stage compression structure is employed, and the refrigerant is compressed to about 15 bars to about 30 bars by the compressors 1021, 1022, 1023, and 1024. Table 5 shows an example of an operation state and energy consumption of each of the compressors 1021, 1022, 1023, and 1024.

TABLE 5

Compressors

| | 1021 | 1022 | 1023 | 1024 |
|---|---|---|---|---|
| Inlet pressure (bar) | 5.1 | 9.3 | 14.0 | 18.7 |
| Outlet pressure (bar) | 9.3 | 14.0 | 18.7 | 20.4 |
| Electrical Energy (MW) | 36.4 | 24.6 | 16 | 4 |

The refrigerant may be cooled to room temperature, for example, 30° C., in an outlet of each of the compressors 1021, 1022, 1023, and 1024. Table 6 shows an example of the temperature and pressure of the refrigerant that has passed through the compressors 1021, 1022, 1023, and 1024.

TABLE 6

| | Inlet of | Outlet of | Outlet of | Outlet of | Outlet of |
|---|---|---|---|---|---|
| | Compressor | Compressor | Compressor | Compressor | Compressor |
| Flow | 1021 | 1021 | 1022 | 1023 | 1024 |
| Temperature | 18 | 30 | 30 | 30 | 30 |
| (° C.) | | | | | |
| Pressure (bar) | 5.1 | 9.3 | 14.0 | 18.7 | 20.4 |

The compressed refrigerant is condensed by the condenser 1025 by heat exchange with a heat exchange fluid. In this regard, the heat exchange fluid may be the sixth gas 206 finally discharged from the heat exchanger 105 of FIG. 7 described above. The temperature of the sixth gas 206 is, for example, about −40° C. to about −10° C., and has considerable cold heat. The sixth gas 206 may be discharged as the seventh gas 207 by providing cold heat to the condenser 1025 to cool the refrigerant passing through the condenser 1025. Table 7 shows an operation state and the amount of heat exchange of the condenser 1025 according to an embodiment. The temperature of the seventh gas 207 may be, for example, room temperature. The temperature of the condensed refrigerant may be, for example, 27.4° C., and the amount of heat exchange between the sixth gas 206 and the refrigerant may be, for example, about 11.1 megawatt (MW). Accordingly, most of the cold heat of the third gas 203 may be recovered, and thus the energy efficiency of the carbon dioxide capturing device may be improved.

TABLE 7

| | | |
|---|---|---|
| Condenser 1025 | Unit | Condition |

| | | | |
|---|---|---|---|
| Temperature | Inlet | ° C. | 30.0 |
| | Outlet | | 27.4 |

| | | |
|---|---|---|
| Amount of heat exchange | MW | 11.1 |

The condensed refrigerant is vaporized in the low-temperature sublimator 102 and cools the second gas 202 by primary heat exchange with the second gas 202. After the primary heat exchange, the refrigerant discharged from the low-temperature sublimator 102 is decompressed and cooled while passing through the expander 1026. Table 8 shows an operation state of the expander 1026 according to an embodiment. Referring to Table 8, the temperature of the refrigerant discharged from the low-temperature sublimator 102 after the primary heat exchange may be, for example, −103° C., and the pressure thereof may be about 20.5 bars. After passing through the expander 1026, the refrigerant has a temperature of, for example, −110.8° C. and a pressure of about 5.1 bars, and has cold heat capable of cooling the second gas 202 to a sublimation temperature.

TABLE 8

| | | |
|---|---|---|
| Expansion valve 206 | Unit | Condition |

| | | | |
|---|---|---|---|
| Pressure | Inlet | bar(a) | 20.4 |
| | Outlet | | 5.1 |
| Temperature | Inlet | ° C. | −103.0 |
| | Outlet | | −110.8 |

The refrigerant that has passed through the expander 1026 is provided again to the low-temperature sublimator 102, and cools the second gas 202 by secondary heat exchange with the second gas 202. Accordingly, the second gas 202 is separated into solid-phase carbon dioxide and the remaining third gas 203. The solid-phase carbon dioxide may be recovered. The concentration of carbon dioxide of a flow including the solid-phase carbon dioxide may be 99.9% or more. The concentration of carbon dioxide of the third gas 203 may be about 5% or less. Table 9 shows an operating state of the low-temperature sublimator 102 according to an embodiment.

TABLE 9

| Low-temperature | | | |
|---|---|---|---|
| sublimator 102 | | Unit | Condition |
| Cooling heat | | MW | 71.0 |
| Cooling temperature | | ° C. | −103 |
| Separation | Composition of carbon | mol % | 25.0 |
| | dioxide in second gas 202 | | |
| | Composition of carbon | | 1.7 |
| | dioxide in third gas 203 | | |
| | Recovered carbon dioxide | | 100.0 |

Table 10 shows the temperature, pressure, flow rate, and composition of each of the second gas 202, the recovered carbon dioxide, and the third gas 203 with respect to the low-temperature sublimator 102.

TABLE 10

| | | Second | Recovered | Third |
|---|---|---|---|---|
| | | gas 202 | carbon dioxide | gas 203 |
| Temperature (° C.) | | −77.5 | −103 | −103 |
| Pressure (bar) | | 2.85 | 2.85 | 2.85 |
| Flow rate (kmol/h) | | 37781 | 8942 | 28839 |
| Composition | CO₂ | 0.250 | 1.000 | 0.017 |
| | N₂ | 0.687 | 0.000 | 0.901 |
| | O₂ | 0.063 | 0.000 | 0.082 |
| | H₂O | 0.000 | 0.000 | 0.000 |

Referring to Tables 9 and 10, for example, the second gas 202 may be cooled to −103° C. in the low-temperature sublimator 102. The amount of heat exchange between the second gas 202 and the refrigerant may be, for example, 71.0 MW. A composition ratio of the carbon dioxide of the third gas 203 is about 1.7%.

The second gas 202 may be cooled in two stages. That is, the second gas 202 may be cooled to a second temperature without a phase change before being provided to the low-temperature sublimator 102. Accordingly, the carbon dioxide capturing method according to an embodiment may further include cooling the second gas 202 to the second temperature without a phase change by providing the second gas 202 to the heat exchanger 105 before providing the second gas 202 to the low-temperature sublimator 102. Referring to FIG. 5, the heat exchanger 105 is disposed between the separator 101 and the low-temperature sublimator 102. The heat exchanger 105 may, for example, heat-exchange the second gas 202 with the refrigerant of the refrigerant-based cooling system 1050 or the refrigerant-based cooling system 1020, thereby cooling the second gas 202 to the second temperature. The second temperature is a temperature that does not cause a phase change of carbon dioxide gas and may be higher than the first temperature. For example, the second temperature may be about −80° C. to about −50° C.

As described above, the temperature of the third gas 203 discharged from the low-temperature sublimator 102 may be about −120° C. to about −70° C. In the example described above, the temperature of the third gas 203 is about −103° C. The third gas 203 has considerable cold heat. The heat exchanger 105 may cool the second gas 202 to the second temperature by using cold heat of the third gas 203. In this case, the refrigerant-based cooling system 1050 may be omitted. Accordingly, the carbon dioxide capturing method according to an embodiment may further include recovering the cold heat of the third gas 203 by directing the third gas 203 to the heat exchanger 105 and heat-exchanging the third gas 203 with the second gas 202. Referring to FIG. 6, the third gas 203 may be discharged from the heat exchanger 105 as the fourth gas 204 after heat exchange with the second gas 202.

As an additional operation for energy recovery, the carbon dioxide capturing method according to an embodiment may further include decompressing the fourth gas 204 through the expander 106 and then redirecting the fourth gas 204 to the heat exchanger 105 as the fifth gas 105 and heat-exchanging the fifth gas 205 with the second gas 202. Referring to FIG. 7, the fourth gas 204 discharged from the heat exchanger 105 after the primary heat exchange with the second gas 202 is supplied to the expander 106. In the expander 106, the fourth gas 204 is decompressed and adiabatically cooled and discharged as the fifth gas 205. Moreover, the power recovery system 107 may be connected to the turbine-type expander 106 to recover electrical energy. Table 11 shows an operating state and an electrical energy production of the expander 106 according to an embodiment. Referring to Table 11, the temperature and pressure of the fourth gas 204 in an inlet of the expander 106 are −35° C. and 2.85 bars, respectively, and the temperature and pressure of the fifth gas 205 in an outlet of the expander 106 are −110° C. and 1.01 bars, respectively. In this regard, about 17 MW of electrical energy may be produced.

TABLE 11

| | | |
|---|---|---|
| Expander 106 | Unit | Condition |

| | | | |
|---|---|---|---|
| Pressure | Inlet | bar(a) | 2.85 |
| | Outlet | | 1.01 |
| Temperature | Inlet | ° C. | −35 |
| | Outlet | | −110 |

| | | |
|---|---|---|
| Electrical energy production | MW | 17 |

The fifth gas 205 is provided to the heat exchanger 105. In the heat exchanger 105, the fifth gas 205 may exchange heat with the second gas 202 (secondary heat exchange) so that the second gas 202 may be cooled. The fifth gas 205 is discharged from the heat exchanger 105 as the sixth gas 206 after the secondary heat exchange. The temperature of the sixth gas 206 may be, for example, about −40° C. to about −10° C.

Table 12 lists the temperature and pressure of the third gas 203, the fourth gas 204, the fifth gas 206, and the sixth gas 206 in a heat recovery process performed in heat exchanger 105. Referring to Table 12, the temperature of the fifth gas 205 increases from about −110° C. to about −27° C. by the secondary heat exchange in the heat exchanger 105, and the cold heat corresponding therefrom is transferred to the second gas 202 so that the second gas 202 is cooled to the second temperature.

TABLE 12

| | | Third | Fourth | Fifth | Sixth |
|---|---|---|---|---|---|
| | | gas 203 | gas 204 | gas 205 | gas 206 |
| Temperature (° C.) | | −103 | −35 | −110 | −27 |
| Pressure (bar) | | 2.85 | 2.85 | 1.01 | 1.01 |
| Flow rate (kmol/h) | | 28839 | 28839 | 28839 | 28839 |
| Composition | CO₂ | 0.017 | 0.017 | 0.017 | 0.017 |
| | N₂ | 0.901 | 0.901 | 0.901 | 0.901 |
| | O₂ | 0.082 | 0.082 | 0.082 | 0.082 |
| | H₂O | 0.000 | 0.000 | 0.000 | 0.000 |

The temperature of the sixth gas 206 is about −40° C. to about −10° C., for example, about −27° C. in the above-described embodiment. Accordingly, the sixth gas 106 still has considerable cold heat. The cold heat of the sixth gas 206 may be used as a heat exchange fluid in an appropriate portion of the carbon dioxide capturing device. In an embodiment, referring to FIG. 2, the carbon dioxide capturing method may further include heat-exchanging the sixth gas 206 discharged from the heat exchanger 105 with the refrigerant in the condenser 1025 of the refrigerant-based cooling system 1020. The sixth gas 206 is discharged as the seventh gas 207 after heat exchange with the refrigerant in the condenser 1025. The temperature of the seventh gas 207 may be room temperature, for example, 20° C. The pressure, flow rate, and composition of the seventh gas 207 may be the same as those of the sixth gas 206.

Table 13 shows an example of results of calculating the power consumption according to the nitrogen permeance and nitrogen/carbon dioxide selectivity of the nitrogen-selective separation membrane module 1013. Referring to Table 13, it may be seen that the required separation membrane area and power consumption vary according to the nitrogen permeance and nitrogen/carbon dioxide selectivity of the nitrogen-selective separation membrane module 1013, and the nitrogen permeance and nitrogen/carbon dioxide selectivity of the nitrogen-selective separation membrane module 1013 may be appropriately determined in consideration of the required separation membrane area and power consumption.

TABLE 13

| | | | | Separation | Power |
|---|---|---|---|---|---|
| | | | | membrane area | Consumption |
| | | | | (m²) (Increase/ | (MW) (Increase/ |
| | Nitrogen | | Pressure | decrease (%) | decrease (%) |
| | permeance | N₂/CO₂ | device | compared to | compared to |
| | GPU | Selectivity | Efficiency | Base Case) | Base Case) |
| Base Case | 1949 | 23.5 | 0.8 | 93.728 | 143.5 |
| | | | 0.9 | 93.728 | 123.4 |
| Case 1 | 1949 | 11.75 | 0.8 | 27,383 (−71%) | 182.5 (+27%) |
| | | | 0.9 | 27,383 (−71%) | 152.4 (+24%) |
| Case 2 | 974.5 | 23.5 | 0.8 | 184,186 (+97%) | 143.5 |
| | | | 0.9 | 184,186 (+97%) | 123.4 |
| Case 3 | 974.5 | 11.75 | 0.8 | 54,766 (−42%) | 182.5 (+27%) |
| | | | 0.9 | 54,766 (−42%) | 152.4 (+24%) |

According to the embodiments of the carbon dioxide capture device and method of the disclosure, a nitrogen-selective separation membrane module is used, and thus carbon dioxide in the gas mixture may be concentrated with a relatively small separation membrane area at high efficiency. Moreover, the pressure of the gas mixture is maintained after passing through the separator, and thus, an additional compression process may be omitted.

The solid-phase carbon dioxide may be recovered using the low-temperature sublimator, and thus the device facility scale is relatively small compared to a device that relies upon low temperature processing and the requisite distillation facilities according to the related art.

While recovering the cold heat of gas (third gas) discharged from the low-temperature sublimator by using the heat exchanger, power recovery may be possible through a decompression process, thereby implementing improved energy efficiency.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A carbon dioxide capturing method comprising:
directing a gas mixture comprising carbon dioxide gas to a separator including a nitrogen-selective separation membrane module,
wherein the nitrogen-selective separation membrane module separates the gas mixture into a CO₂-depleted first gas and a CO₂-enriched second gas;
directing the CO₂-enriched second gas to a low-temperature sublimator to provide solid-phase carbon dioxide and a third gas, by cooling the CO₂-enriched second gas to a first temperature by heat exchange with a refrigerant of a first refrigerant-based cooling system; and
isolating the carbon dioxide gas from the solid phase by sublimation.

2. The carbon dioxide capturing method of claim 1, wherein the nitrogen-selective separation membrane module has a nitrogen permeance of at least 1 gas permission unit or more and a nitrogen/carbon dioxide selectivity of at least 2 or more.

3. The carbon dioxide capturing method of claim 1, further comprising: compressing the gas mixture in a range of about 1.2 bars to about 5 bars before directing the gas mixture to the separator.

4. The carbon dioxide capturing method of claim 1, further comprising: removing moisture from the gas mixture before directing the gas mixture to the separator.

5. The carbon dioxide capturing method of claim 1, wherein a temperature of the gas mixture provided to the separator is about 10° C. to about 150° C.

6. The carbon dioxide capturing method of claim 1, wherein the first temperature is about −120° C. to about −90° C.

7. The carbon dioxide capturing method of claim 1, further comprising: cooling the CO₂-enriched second gas to a second temperature without a phase change by directing the CO₂-enriched second gas to a heat exchanger before directing the CO₂-enriched second gas to the low-temperature sublimator.

8. The carbon dioxide capturing method of claim 7, wherein the second temperature is about −80° C. to about −50° C.

9. The carbon dioxide capturing method of claim 7, wherein the cooling of the CO₂-enriched second gas to the second temperature comprises heat-exchanging the second gas with a second refrigerant-based cooling system.

10. The carbon dioxide capturing method of claim 7, wherein the cooling of the CO₂-enriched second gas to the second temperature comprises recovering cold heat of the third gas by supplying the third gas to the heat exchanger and heat-exchanging the third gas with the CO₂-enriched second gas.

11. The carbon dioxide capturing method of claim 10, wherein the third gas is discharged from the heat exchanger as a fourth gas after heat exchange with the CO₂-enriched second gas,
and directing the fourth gas to an expander to decrease the temperature of the fourth gas to provide a fifth gas.

12. The carbon dioxide capturing method of claim 11, further comprising redirecting the fifth gas to the heat exchanger and heat-exchanging the fifth gas with the CO₂-enriched second gas.

13. The carbon dioxide capturing method of claim 12, wherein the fifth gas is discharged from the heat exchanger as a sixth gas after heat exchange with the CO₂-enriched second gas,
and directing the sixth gas to a condenser of the first refrigerant-based cooling system and heat exchanging the sixth gas with the refrigerant in the condenser.

14. The carbon dioxide capturing method of claim 1, wherein the refrigerant of the first refrigerant-based cooling system comprises a mixed refrigerant comprising methane, ethane, ethylene, propane, and butane.

15. The carbon dioxide capturing method of claim 14, wherein the mixed refrigerant comprises about 10 mole percent to about 40 mole percent of methane, about 10 mole percent to about 30 mole percent of ethane, about 10 mole percent to about 40 mole percent of ethylene, about 10 mole percent to about 15 mole percent of propane, and about 10 mole percent to about 40 mole percent of butane.

16. A carbon dioxide capturing device comprising:
a compressor configured to compress a gas mixture comprising carbon dioxide to about 1.2 bars to about 5 bars;
a separator comprising a nitrogen-selective separation membrane module to separate the gas mixture into a CO₂-depleted first gas and a CO₂-enriched second gas, wherein the CO₂-depleted first gas permeates the nitrogen-selective separation membrane module;
a first refrigerant-based cooling system; and
a low-temperature sublimator configured to separate the CO₂-enriched second gas into solid-phase carbon dioxide and a third gas by cooling the CO₂-enriched second gas to about 120° C. to about −90° C. through heat exchange with a refrigerant of the first refrigerant-based cooling system and isolating the carbon dioxide.

17. The carbon dioxide capturing device of claim 16, wherein the nitrogen-selective separation membrane module has a nitrogen permeance of at least 1 gas permission unit or more and a nitrogen/carbon dioxide selectivity of at least 2 or more.

18. The carbon dioxide capturing device of claim 16, further comprising a heat exchanger configured to cool the CO₂-enriched second gas to about −80° C. to about −50° C. without a phase change by heat-exchanging the CO₂-enriched second gas with the third gas before directing the CO₂-enriched second gas to the low-temperature sublimator.

19. The carbon dioxide capturing device of claim 18, wherein
the third gas is discharged from the heat exchanger as a fourth gas after heat exchange with the second gas,
and directing the fourth gas to an expander to decrease the temperature of the fourth gas to provide a fifth gas,
the fifth gas is redirected to the heat exchanger and heat-exchanged with the CO₂-enriched second gas.

20. The carbon dioxide capturing device of claim 19, wherein
the fifth gas is discharged from the heat exchanger as a sixth gas after heat exchange with the CO₂-enriched second gas, and
the sixth gas is directed to a condenser of the first refrigerant-based cooling system and heat-exchanged with the refrigerant.
